(19) United States
(12) Patent Application Publication
(10) Pub. No.: US 2022/0250315 A1
(43) Pub. Date: Aug. 11, 2022

(54) 3D Printing of Low Melting Point Materials

(71) Applicant: BOARD OF TRUSTEES OF THE UNIVERSITY OF ARKANSAS, Fayetteville, AR (US)

(72) Inventors: Wenchao Zhou, Springdale, AR (US); Edidiong Nseowo Udofia, Fayetteville, AR (US); Brian Luttrell, Fayetteville, AR (US); Robert Jacobson, Kansas City, MO (US); Sameer Kulkarni, Bryant, AR (US); Salman Khalid, Fayetteville, AR (US); John Bardsley, Fayetteville, AR (US)

(73) Assignee: BOARD OF TRUSTEES OF THE UNIVERSITY OF ARKANSAS, Fayetteville, AR (US)

(21) Appl. No.: 17/629,350

(22) PCT Filed: Jul. 23, 2020
(86) PCT No.: PCT/US2020/043347

§ 371 Date: Jan. 21, 2022

Related U.S. Application Data
(60) Provisional application No. 62/877,799, filed on Jul. 23, 2019.

(51) Int. Cl. B29C 64/209; B29C 64/106; B29C 64/295; B33Y 10/00; B33Y 30/00; B33Y 70/00

(52) U.S. Cl. CPC B29C 64/209; B29C 64/106; B29C 64/295; B29K 2105/0061; B33Y 30/00; B33Y 70/00; B33Y 10/00

(57) ABSTRACT

A system and method that enables 3D printing of ballistics gel and other low melting point materials.

### RELATED APPLICATIONS

This application is a U.S. National Phase of PCT/US2020/043347, which claims priority to U.S. Provisional Application Serial No. 62/877,799 filed on 23 Jul. 2019, both of which are incorporated herewith in their entirety.

### BACKGROUND OF THE INVENTION

Ballistics gelatin is a type of gelatin specifically formulated to simulate the human body and is used in a wide variety of experimental environments, from military and law enforcement to medical professionals. While this type of gel has proven successful in the ballistics market due to its human flesh-like properties, and a wide range of tunable hardness(by slightly adjusting the composition of the recipe), and unmatched optical clarity (for some of the gel in the market, e.g., Clear Ballistics gel), its promise for other potential applications (e.g., medical and optical) are yet to be fully explored because the fabrication process relies on a conventional molding method, which limits the complexity of the structure that can be made and is time-consuming and expensive for an iterative design process. However, due to its flexibility, it cannot be printed with current 3D printers.

### BRIEF SUMMARY OF THE INVENTION

In one embodiment, the present invention provides a system and method that enables 3D printing of ballistics gel and other low melting point materials.

In one embodiment, the present invention provides a system and method that will provide a significant boost for ballistics gel applications such as new medical markets including, but not limited to, pre-surgical planning, medical education, and medical equipment testing.

In one embodiment, the present invention provides a system and method that enable 3D printing of ballistics gel materials and other low melting point materials for use in optics.

In one embodiment, the present invention provides a system and method that enable 3D printing of ballistics gel materials and other low melting point materials by using a syringe-based printhead for printing relatively small structures with fine features.

In one embodiment, the present invention provides a system and method that enable 3D printing of ballistics gel materials and other low melting point materials by using a gear pump-based printhead for printing relatively large structures.

In one embodiment, the present invention provides a system and method that enable gel extrusion printing (or GEP).

In one embodiment, the present invention provides a system and method that enable 3D printing of ballistics gel materials and other low melting point materials by using a syringe-based printhead for printing relatively small structures with fine features with an extrusion-based 3D printer with precision motion stages.

In one embodiment, the present invention provides a system and method that enable 3D printing of ballistics gel materials and other low melting point materials by using a gear pump-based printhead for printing relatively large structures with a regular low-cost Fused Deposition Modeling (FDM) printer.

In one embodiment, the present invention provides a system and method that enable 3D printing of ballistics gel materials and other low melting point materials thereby providing an inexpensive way to retrofit a low-cost FDM printer for printing ballistics gel materials and other low melting point materials.

In one embodiment, the present invention provides a system and method that enable 3D printing of ballistics gel materials and other low melting point materials thereby providing a digital manufacturing tool for making complex structures to simulate a human body and parts thereof.

In one embodiment, the present invention provides a system and method that enable 3D printing of ballistics gel materials and other low melting point materials thereby providing a flexible 3D printable material that provides unparalleled flexibility/elasticity to any current 3D printable materials.

In one embodiment, the present invention provides a system and method that enable 3D printing of ballistics gel materials and other low melting point materials thereby providing a new type of 3D printable material that can be used as a material for support structures or sacrificial materials due to its relative low melting point compared to other 3D printable materials (and thus can be easily melted away after printing).

In one embodiment, the present invention provides a system and method that enable 3D printing of ballistics gel materials and other low melting point materials thereby providing a clear 3D printable material that can be used in various optical devices due to its low optical transmission loss and similar refractive index compared to glass (yet with much lighter density and flexibility).

In one embodiment, the present invention provides a system and method that enable new extrusion methods that enable the printing of any materials that can be melted into liquid form at relatively low temperature, such as chocolate, wax, etc.

In other aspects, the present invention provides a system and method that enables 3D printing of ballistics gel and other low-melting-point materials which have the following advantages when compared to other 3D printable materials: (1) unparalleled flexibility since the embodiments of the present invention are far more flexible than the most flexible 3D printable materials in the market; (2) human tissue resemblance whereby it can simulate human body for different applications in defense and medical industries; (3) the ability to print gels having optical clarity and good optical performance with low density and flexibility enabling new optical applications; and (4) the ability to print gels having a low melting point for support structures and sacrificial materials.

In other aspects, the present invention provides a system and method that enables 3D printing of ballistics gel and other low-melting-point materials which has the following advantages when compared to gel molding techniques: (1) the ability to create complex models at low cost; has a fast turnaround time; and has ease of use.

In other aspects, the present invention provides a system and method that enables 3D printing of ballistics gel and other low-melting-point materials using a plurality of printers, which may be on mobile platforms, that are combined together for swarm printing. This enables the printing of larger, complex print jobs that may be used to simulate complex biological systems.

In other aspects, the present invention provides a system and method that enables 3D printing of ballistics gel by extruding the gel using a gear pump and by first heating and liquifying the gel.

In other aspects, the present invention provides a system and method that enables 3D printing of ballistics gel to create complex and custom models of the human body. These models could be implemented to replace traditional cadaver research, first response training such as CPR, or even for research such as fluid flow analysis of the heart.

In other aspects, the present invention provides a system and method that enables 3D printing of ballistics gel by keeping all elements of the system heated around 100° C. to prevent any gel solidifying during the entire printing process. This includes everything from the mouth of the supply tank to the tip of the nozzle.

In other aspects, the present invention provides a system and method that enables 3D printing of ballistics gel for applications including unique artistic illumination, caustic patterns, beam splitter and combiner on both planar and 3D conformal surfaces, and optical encoder. The printed waveguides exhibit an outstanding optical transparency of more than 98% and an optical loss of less than 0.22 dBcm-1. The simplicity of the fabrication process, low-cost, excellent optical properties, and flexibility provided by the present invention are an attractive pathway for fabricating integrated optical devices and new opportunities for controlling light.

In other aspects, the present invention provides a new method to fabricate structures with Clear Ballistics gel to enable new applications. To this end, the embodiments of the present invention provide a microextrusion-based 3D printer that can print the gel in the open air without the need of a support bath or supporting materials for use in a variety of optical applications.

In other aspects, the present invention provides a system and method that enable 3D printing of ballistics gel and other low melting point materials.

In other aspects, the present invention provides a system and method to 3D print materials and other low melting point materials for medical markets including, but not limited to, pre-surgical planning, medical education, and medical equipment testing.

In other aspects, the present invention provides a system and method to 3D print materials and other low melting point materials for use in optics.

In other aspects, the present invention provides a system and method to 3D print materials and other low melting point materials using a syringe-based printhead for printing relatively small structures with fine features.

In other aspects, the present invention provides a system and method to 3D print materials and other low melting point materials using a gear pump-based printhead for printing relatively large structures.

In other aspects, the present invention provides a system and method that enable 3D printing of ballistics gel and other low melting point materials that enable gel extrusion printing (or GEP).

In other aspects, the present invention provides a system and method that enable 3D printing of ballistics gel and other low melting point materials that enable 3D printing of ballistics gel materials by using a syringe-based printhead for printing relatively small structures with fine features with an extrusion-based 3D printer with precision motion stages.

In other aspects, the present invention provides a system and method that enable 3D printing of ballistics gel and other low melting point materials that enable 3D printing of ballistics gel materials by using a gear pump-based printhead for printing relatively large structures with a regular low-cost Fused Deposition Modeling (FDM) printer.

In other aspects, the present invention provides a system and method that enable 3D printing of ballistics gel and other low melting point materials that enable 3D printing of ballistics gel materials thereby providing an inexpensive way to retrofit a low-cost FDM printer for printing ballistics gel materials.

In other aspects, the present invention provides a system and method that enable 3D printing of ballistics gel and other low melting point materials that enable 3D printing of the materials thereby providing a digital manufacturing tool for making complex structures to simulate a human body or portions thereof.

In other aspects, the present invention provides a system and method that enable 3D printing of ballistics gel and other low melting point materials that enable 3D printing of the materials thereby providing a 3D printable material that can be used as a material for support structures or sacrificial materials due to its relative low melting point compared to other 3D printable materials (and thus can be easily melted away after printing).

In other aspects, the present invention provides a system and method that enable 3D printing of ballistics gel and other low melting point materials that enable 3D printing of the materials thereby providing a clear 3D printable material for use with optical devices due to its low optical transmission loss and similar refractive index compared to glass (yet with a much lighter density and flexibility).

In other aspects, the present invention provides a syringe-based printhead comprising: a glass syringe inside a metal casing, which is wrapped by a thin-film heater; the syringe can be either connected to a pressure source controlled by a digital valve or a motor-driven plunger; and the syringe printhead is then mounted onto an XYZ stage for 3D printing.

In other aspects, the present invention provides a system and method wherein during printing, a solid gel is placed inside the syringe barrel, which is then heated to melt the gel into liquid before printing.

In other aspects, the present invention provides a system and method wherein the syringe-based printhead is adapted to have 1) uniformity of heating; 2) heat insulation with other components; 3) the capability of maintaining a constant temperature between 70 to 130° C.; and 4) the capability of being used with a needle size smaller than 100 um.

In other aspects, the present invention provides a gear pump-based gel printhead comprising: a supply tank, a gear pump, a nozzle, tubing for connection between the components, and a plurality of heaters for maintaining a constant temperature throughout the entire system to prevent the gel from solidifying and clogging.

In other aspects, the present invention provides a system and method wherein the gear pump-based printhead is adapted to have 1) uniformity of the heating; 2) heat insulation with other components; 3) the capability of maintaining a constant temperature that can melt a wide range of materials; and 4) the capability of continuously supplying the gel.

### BRIEF DESCRIPTION OF THE SEVERAL VIEWS OF THE DRAWINGS

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, a detailed description of certain embodiments discussed in the present document.

FIG. 1A is a schematic illustration of first embodiment of the present invention.

FIG. 1B shows a heating chamber and nozzle assembly for an embodiment of the present invention.

FIG. 1C shows a nozzle assembly for an embodiment of the present invention.

FIG. 2A provides an example of overall design components for an embodiment of the present invention.

FIG. 2B illustrates a printing system for a second embodiment of the present invention.

FIG. 2C shows a bottom view of a gear pump assembly that may be used with an embodiment of the present invention.

FIG. 2D is exploded view of a gear pump assembly that may be used with an embodiment of the present invention.

FIG. 2E is cutaway view of a nozzle that may be used with an embodiment of the present invention.

FIG. 2F illustrates a method of heating tubing used in the embodiments of the present invention.

FIG. 3 is a printing procedure that may be used with the embodiments of the present invention.

FIGS. 4A, 4B and 4C are rheological flow curves of Clear Ballistics gel (#20) that indicate a shear thickening behavior. While an increase in the melting temperature results in lower viscosity it has a negative impact on the print resolution. Lower melting temperature enables the creation of high-resolution structures that retain cylindrical shape upon deposition but is limited by the requirement of high deposition pressure.

FIG. 5A is an optical image of a straight waveguide printed from a 210 μm nozzle.

FIG. 5B is an optical image of a straight waveguide printed from an 810 μm nozzle.

FIG. 5C is an optical image of a curved waveguide printed from an 810 μm nozzle.

FIG. 5D is a high-resolution surface image of the printed gel filament using an optical microscope showing a smooth surface of the gel.

FIG. 6A is an optical image of 8, 16 and 32 layers of woodpile structures printed using an embodiment of the present invention.

FIG. 6B is a cross-sectional cut through showing that the gel filaments maintained their cylindrical structure. Printing was carried out using an 810 μm nozzle with in-plane center-to-center filament spacing of 1.5 mm. Scale bar=1600 μm.

### DETAILED DESCRIPTION OF THE INVENTION

Detailed embodiments of the present invention are disclosed herein, however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed method, structure or system. Further, the terms and phrases used herein are not intended to be limiting, but rather to provide an understandable description of the invention.

In a preferred embodiment, the present invention provides systems and methods of 3D printing of ballistics gel and other low-melting-point materials that use syringe-based printheads. In another preferred embodiment, the present invention provides systems and methods of 3D printing of ballistics gel and other low-melting-point materials that use gear pump-based printheads.

Syringe-Based Gel Printhead

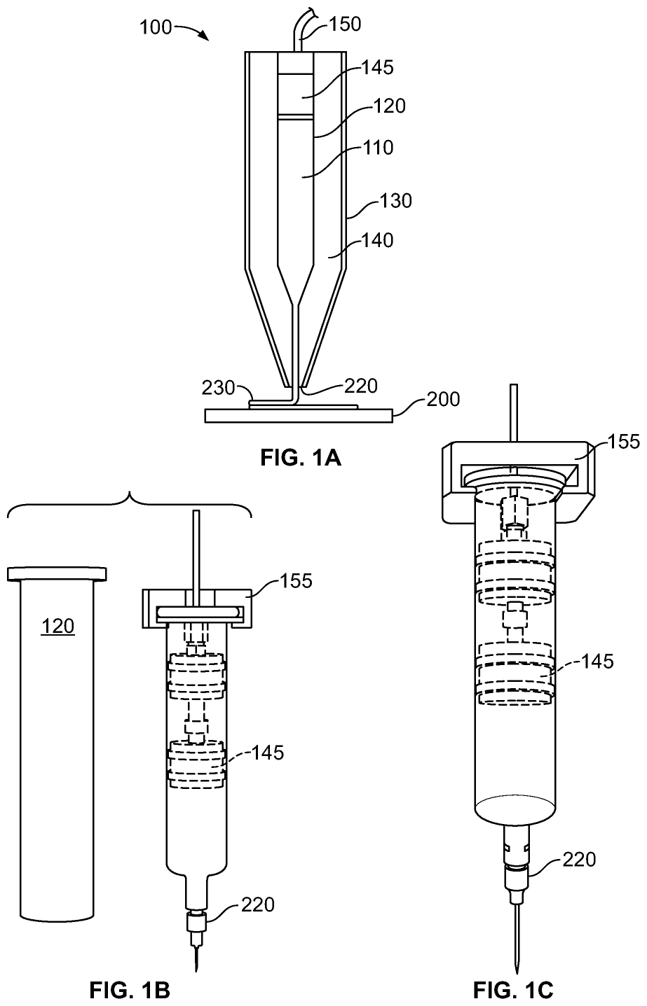

As shown in FIGS. 1A-1C, the syringe-based printhead 100 consists of a glass syringe 110 inside a metal casing 120, which is wrapped by a thin-film heater 130. The syringe 100 and plunger 145 can be either connected to a pressure source 150 controlled by a digital or a motor-driven plunger. In other embodiments, syringe 100 is separated from heating element 130 by heating chamber 140.

A pressure regulator or adapter 155 may be used to regulate the internal pressure of the system. It may be adapted to function as a digital control valve operable by appropriate software which is discussed below.

The syringe printhead is then mounted onto an XYZ stage 200 for 3D printing. During printing, solid gel is placed inside the syringe which is then heated to melt the gel into liquid before the printing starts through nozzle 220 which creates a gel filament 230. The syringe-based printhead is specifically designed to meet the following challenges: 1) uniformity of the heating; 2) good heat insulation with other components; 3) capable of maintaining a constant temperature between 70 to 130° C.; 4) being able to print with a needle or nozzle size smaller than 100 um.

Gear Pump-Based Gel Printhead

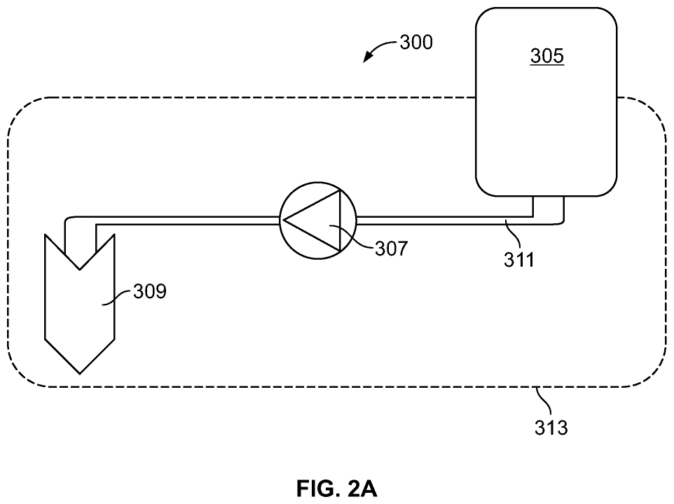

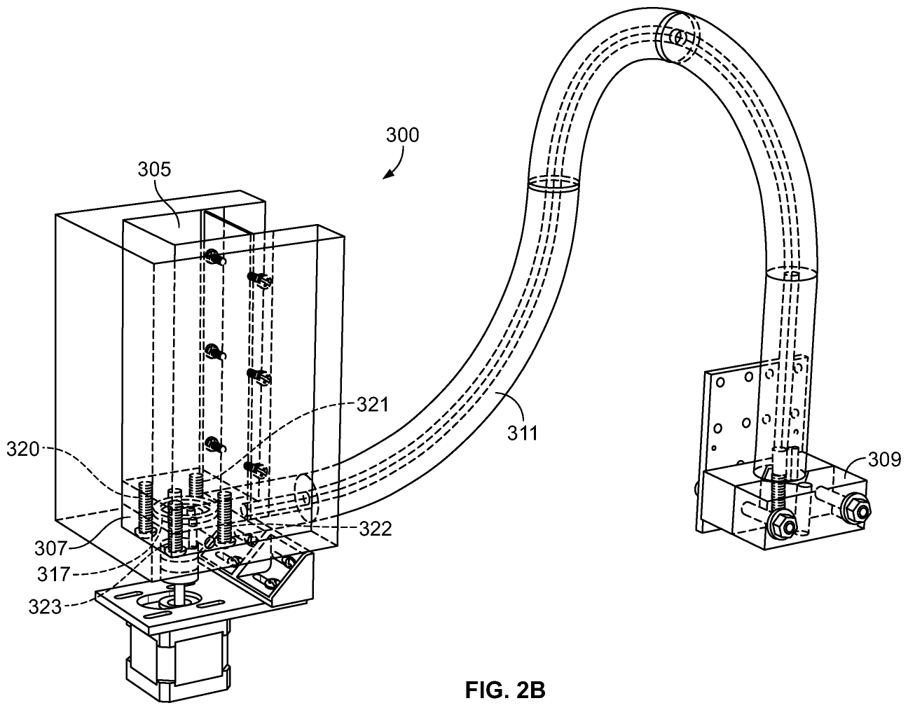

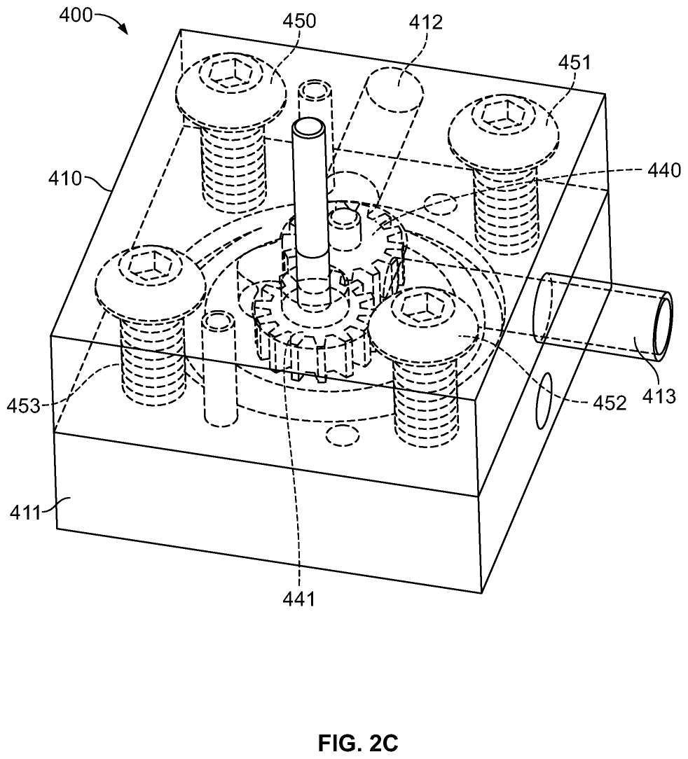

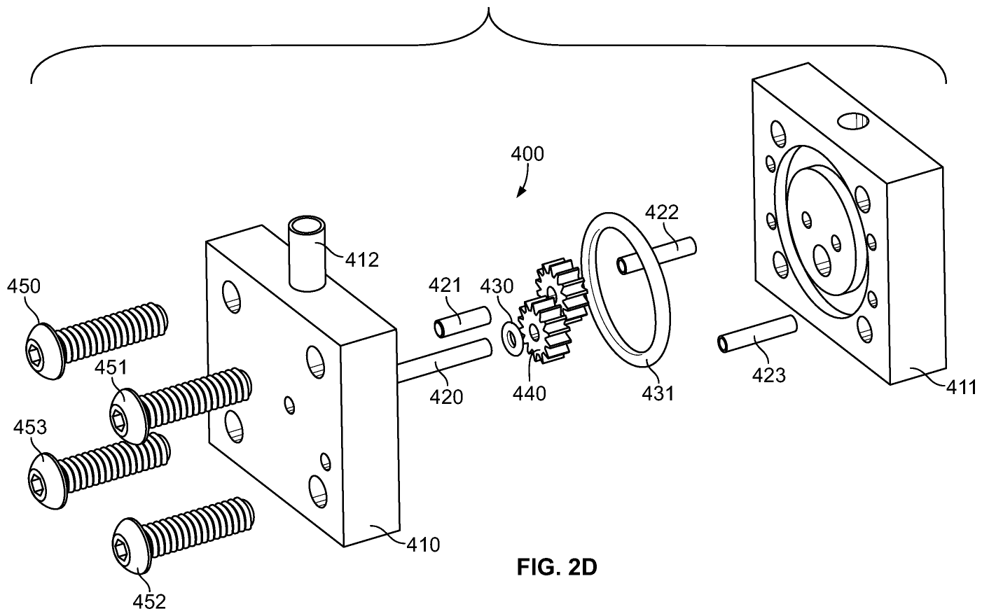

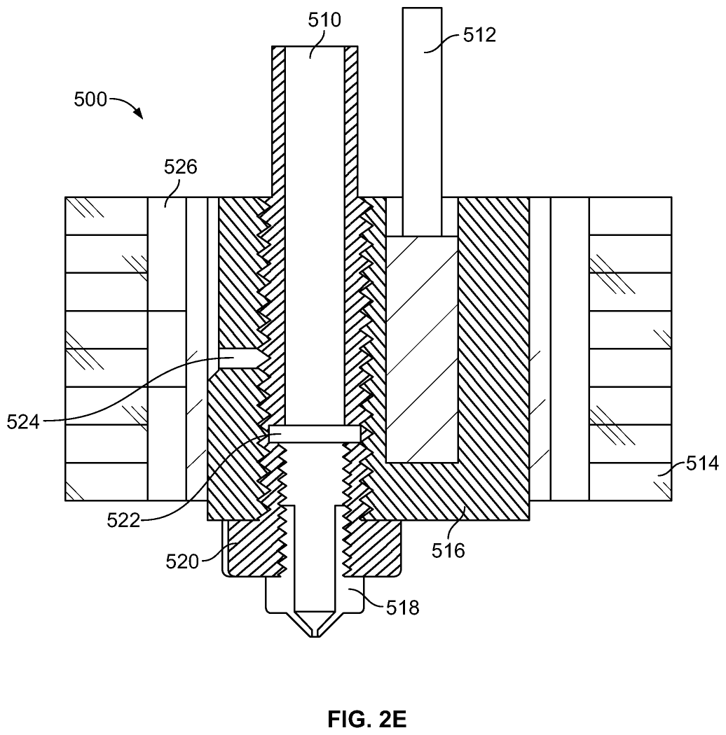

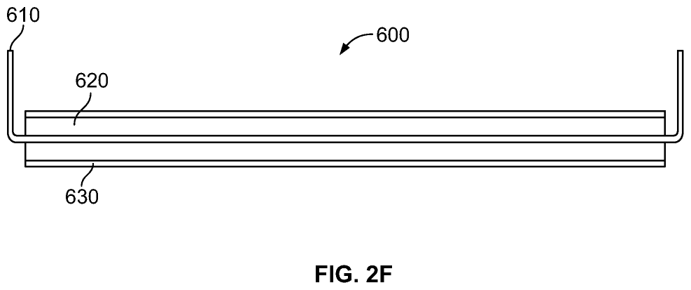

Because a syringe barrel has limited volume and is not suitable to print large structures, a gear pump-based printhead having continuous printing of an unlimited volume of gel may be used as shown in FIGS. 2A-2E. The printhead system 300 consists of a supply tank 305, a gear pump 307, a nozzle 309, tubing 311 for connection between the components, and one or more heaters 313 for maintaining a constant temperature throughout the entire system to prevent the gel from solidifying and clogging. The gear pump-based printhead is specifically designed to meet the following challenges: 1) uniformity of the heating; 2) good heat insulation with other components; 3) capable of maintaining a constant temperature that can melt a wide range of materials; 4) being able to continuously supply the gel.

In one preferred environment of the present invention, as shown in FIGS. 2B, storage tank 305 is integrated with pump 307. This eliminates the need for any tubing between the two. Tank 305 may be constructed of metal extrusions or sheet metal bolted together and then siliconed or welded at the seams to form an elongated steel tube. At the bottom of tank 305 is aluminum block 317, which serves as the pump face plate. Tank 305 and includes a port adapted to permit melted gel to enter the low-pressure side of the pump. Pump face plate 307 may also house a ceramic heater 317 which is used to melt the gel in the system. Bolted connections 320-323 that mounted the pump body to the face plate. In order to conserve heat, the entire tank assembly was then wrapped in Styrofoam insulation (not shown for clarity).

FIGS. 2C-2D illustrate a preferred and pump embodiment for the present invention. As shown, gear pump 400 the embodiment includes bolted plates 410 and as well as inlet port 412 which is in communication with the storage tank and outlet port 413 which is in communication with a nozzle typically via tubing. Also included are pins 420 through 423, O-rings 430 and 431, and gears for hundred 4 40 and 441. The entire assembly may be fastened together by fasteners 450-453.

FIG. 2E illustrates a preferred nozzle design 500 of the present invention. This embodiment, as with other parts of the system, must also be kept at ˜100° C. but the heat could not be allowed to be transmitted to other parts of the printer. This embodiment includes tubing 510, ceramic heater 512 clamp 514, nozzle holder 516, nozzle 518, which is held in place by nozzle bolt 520. Also included is an optional valve to enforce sure one-way flow. Design also includes a thermistor port 524 as well as insulation 526 which may be made of cork or other thermally insulating materials.

FIG. 2F illustrates a preferred tubing design 600 of the present invention which involves a single strand of resistive wire 610 threaded through the interior 620 of the tubing 630. This gives the direct gel-to-wire interaction while keeping the length of the wire at a minimum. The entire tubing was then insulated using a rubber insulation to conserve heat while still maintaining tubing flexibility. After initial thermal calculations, it was determined that keeping the wire coaxially centered was not a concern because the tubing was small enough that with proper insulation, the gel would still maintain a consistent temperature despite the actual position of the wire within the tube. In order to utilize the resistive heating wire while being suspended in the tubing, electrical connections would need to be made at each end of the wire. To do this, the wire may be compressed between the metal and tubing when it is pressed onto the nozzle and pump fittings. Then, electrical connections would be made to the pump and the nozzle in order to complete the circuit.

Description of the Software System

The entire system may be digitally controlled to enable automation and seamless control of tool pathways. The components of the present invention may be configured to read a standard code such as a G-code file, interpret, and convert it to control signals for precise regulation of the XYZ motion stages, and the printhead.

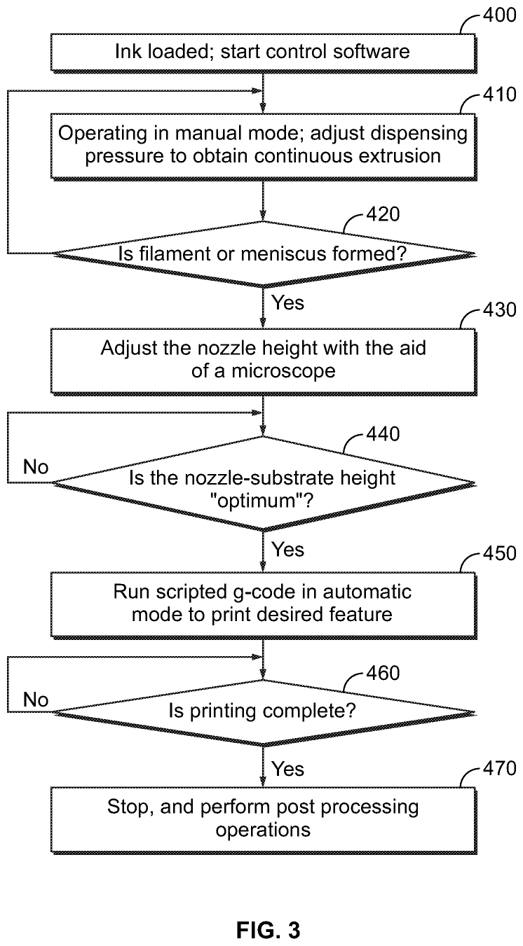

FIG. 3 provides an overview of the software implementation, which integrates the motion and printhead subsystems that may be used with the embodiments of the present invention. As shown, exemplary steps may include the following: step 800, load material, start control software; step 810, adjust dispensing pressure to obtain continuous extrusion; step 820, confirm a filament or meniscus is formed; step 830, adjust nozzle height preferably with the aid of a microscope; step 840, confirm nozzle substrate height is optimal; step 850, software script to print desired feature; step 860, confirm printing is complete; and step 870, perform post processing operations.

In other embodiments, the system can be operated in two modes—manual and automated. In the manual mode, the user can vary the printing parameters to determine the optimum printing condition (e.g., extrusion pressure, and standoff gap). When in the automated mode, the software reads a G-code file, generated from open source slicer software (e.g., Repetier Host), parses the file, and sends control signals to the XYZ motors and pressure regulator. This process is repeated until all the G-codes are systematically executed.

An important part of the software is how the standard RepRap G-code template (e.g., Gnn Xnnn Ynnn Znnn Ennn Fnnn) was modified. The “Enn” parameter regulates the dispensing pressure valve instead of motor speed, as used routinely by the fused deposition modeling (FDM) printers. Therefore, whenever the E parameter appears in the G-code line, the digital valve changes the magnitude of supplied pressure. For example, G01 E20 changes the pressure set point to 20 psi. The other parameters remain unchanged, performing the similar functions as the FDM printer. For example, Gnn is the G-code of interest, Xnnn, Ynnn, and Znnn are the positions in X, Y, and Z coordinate to be translated. F represents the translation speed (mm/s) to move between the starting point and ending point, and “nnn” is simply a numerical modifier, representing, in the quantitative sense, how each parameter is changing.

To evaluate if the embodiments of the present invention meet target resolutions, a series of serpentine patterns using polydimethylsiloxane (PDMS). Resolutions of ˜10 μm were printed.

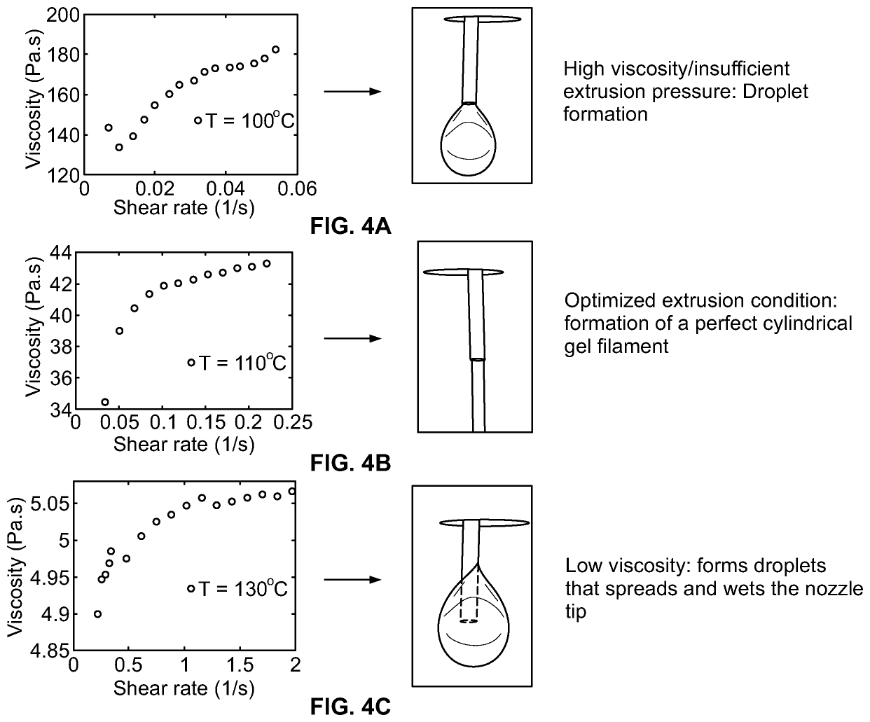

To optimize the process parameters, ink viscosity was characterized as a function of shear rate at a temperature ranging from 80 to 130C. FIGS. 4A-4C show that the gel exhibits a shear thickening behavior (only the results for gel grade #20 at 100, 110 and 130° C. are shown here). FIGS. 4A-4C compare the results of the gel extrusion using a fixed nozzle diameter (D=210 μm) and applied pressure (P=100 psi). At a low heating temperature (80 to 100° C.), viscosity increases significantly, and the dispensing process requires very high pressure to sustain consistent flow rates. On the other hand, at higher heating temperature (110° C.) when viscosity decreases, the gel oozes out of the nozzle tip even with no applied pressure and forms a droplet that wets the nozzle surface. Consistent gel extrusion was achieved at a temperature of 110° C. with modest deposition pressures. A temperature change of 30° C. (from 100 to 130° C.) results in a viscosity change of almost two orders of magnitude. With careful selection of the nozzle diameter, printing speed, temperature, and applied deposition pressure, the printing resolution and quality may be controlled.

Characterization of Printed 2D and 3D Structures

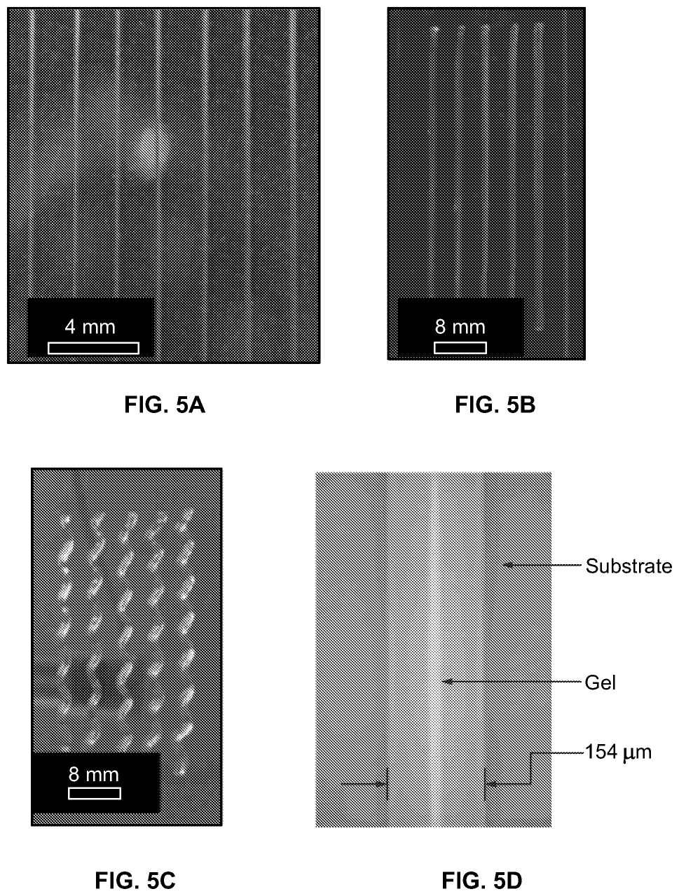

As shown in FIGS. 5A-5D, the embodiments of the present invention used to print a variety of straight and curved planar structures. These structures highlight the ability to control filament geometry and size. For example, FIG. 5A demonstrates an ability of printing and optical waveguide having a consistent printing resolution of 154 μm using a nozzle with a diameter of 210 μm. FIGS. 5B and 5C demonstrate straight and curved waveguides printed using an 810 μm nozzle. FIG. 5D is a high-resolution surface image of the printed gel filament using an optical microscope (VHX-2000, Keyence) showing a smooth surface of the gel.

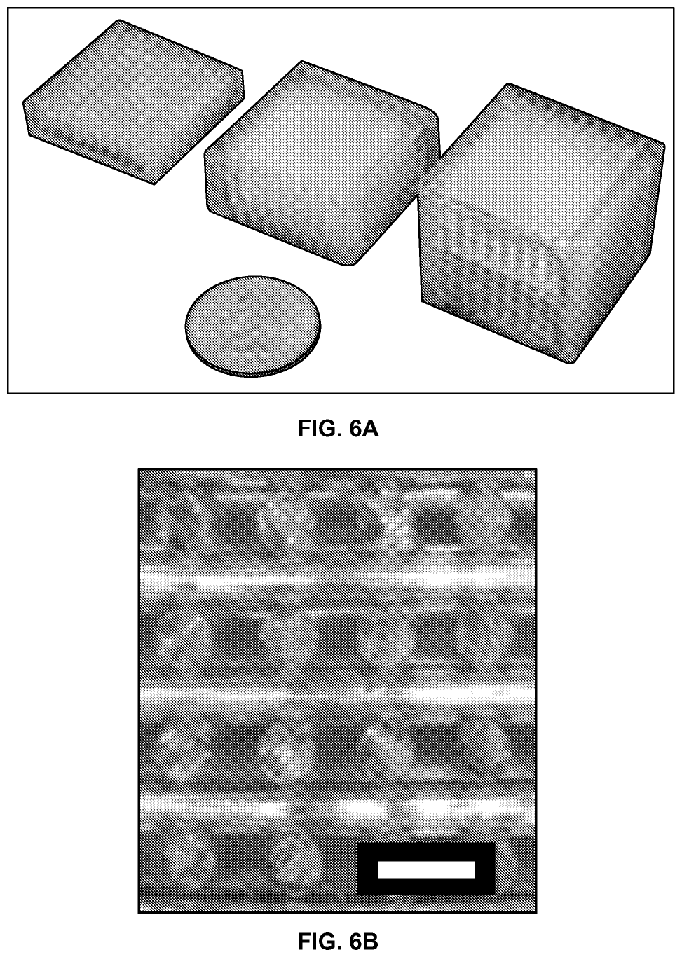

Furthermore, a broad range of 3D periodic woodpile structures, including 8, 16 and 32-layers covering an area of 30 mm×30 mm were printed as shown in FIGS. 6A and 6B. The cross-sectional cut through the printed structure reveals that the filaments maintained a good cylindrical shape with a diameter conforming to the nozzle diameter. To investigate the mechanical stretchability and elastic recovery, a uniaxial strain applied to the printed gel filament revealed the ability to be strained up to 100% and elastically recover. The mechanical flexibility of the gel was confirmed by twisting around a cylindrical rod to form a helical profile. In addition, to determine the ultimate strain and Young's modulus, a uniaxial tensile test was carried out using molded dumb-bell test specimen. The Young's modulus was determined to be 77.6 kPa (from the 5-20% linear strain) and a maximum (failure) strain of 292%. The flexible nature of this material makes it an attractive candidate for optical based strain sensors.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above-described embodiments, methods, and examples, but by all embodiments and methods within the scope and spirit of the disclosure.

1. A syringe-based printhead comprising: a syringe inside a heated casing and an XYZ stage connected to said syringe.

2. The device of claim 1 wherein said casing is wrapped by a thin-film heater.

3. The device of claim 1 wherein said casing is wrapped by a wire heater.

4. The device of claim 1 wherein said syringe-based printhead is connected to a pressure source controlled by a digital valve.

5. The device of claim 1 wherein said syringe-based printhead is connected to a motor-driven plunger.

6. The device of claim 1 wherein said syringe-based printhead is adapted to have 1) uniformity of heating; 2) heat insulation with other components; 3) the capability of maintaining a constant temperature between 70 to 130° C.; and 4) the capability of being used with a needle size smaller than 100 um.

7. (canceled)

8. (canceled)

9. (canceled)

10. (canceled)

11. A method to 3D print ballistics gel comprising the steps of: providing a syringe-based printhead, said syringe-based printhead comprising: a syringe inside a heated casing and said syringe printhead is mounted onto an XYZ stage for 3D printing; supplying melted ballistics gel to said syringe; and operating said XYZ stage to move said nozzle during printing.

12. The method of claim 11 wherein during printing, a solid gel is placed inside the syringe barrel, which is then heated to melt the gel into liquid before printing.

13. The method of claim 11 wherein said casing is heated by a thin-film heater.

14. The method of claim 11 wherein said casing is heated by a wire heater.

15. The method of claim 11 wherein said syringe-based printhead is connected to a pressure source controlled by a digital valve.

16. The method of claim 11 wherein said syringe-based printhead is syringe connected to a motor-driven plunger.

17. The method of claim 11 wherein during printing, a solid gel is placed inside a tank connected to said syringe barrel, which is then heated to melt the gel into liquid before printing.

18. The method of claim 11 wherein said syringe-based printhead is adapted to have 1) uniformity of heating; 2) heat insulation with other components; 3) the capability of maintaining a constant temperature between 70 to 130° C.; and 4) the capability of being used with a needle size smaller than 100 um.

19. (canceled)

20. (canceled)

21. (canceled)

22. The methods of claim 11 wherein said methods are used to 3D print materials for medical markets including, but not limited to, pre-surgical planning, medical education, and medical equipment testing

23. The methods of claim 11 wherein said methods are used to 3D print materials for for use in optics.

24. The methods of claim 11 wherein said methods are used to 3D print small structures.

25. The methods of claim 11 wherein said methods are used to 3D print small structures with fine features.

26. The methods of claim 11 wherein said methods are used to 3D print large structures.

27. (canceled)

28. (canceled)

29. (canceled)

30. (canceled)

31. (canceled)

32. (canceled)

33. (canceled)
